(19) United States
(12) Patent Application Publication
(10) Pub. No.: US 2012/0267864 A1
(43) Pub. Date: Oct. 25, 2012

(54) GASKET AND SEAL STRUCTURE

(75) Inventors: Takeshi Watanabe, Makinohara-shi (JP); Shigenobu Honda, Weinheim (DE); Hiroaki Sato, Aso-shi (JP)

(73) Assignee: NOK CORPORATION,TOKYO, JAPAN, Tokyo (JP)

(21) Appl. No.: 13/512,239

(22) PCT Filed: Nov. 12, 2010
(86) PCT No.: PCT/JP2010/070210

§ 371 Date: May 25, 2012

(30) Foreign Application Priority Data
Nov. 30, 2009 (JP) 2009-272625

(51) Int. Cl. F16J 15/06

(52) U.S. Cl. 277/648

(57) ABSTRACT

Provided are a gasket and a seal structure, which can exhibit a sealing property without being affected by the state of a contact surface of an attached object. A plurality of lip portions (3) which are brought into contact with a groove bottom surface (42) of a groove (41) of one of members to which a gasket (1) is attached or one of the surfaces of the other member, to form a seal surface, are provided. A recessed portion (3a) is formed between the lip portions (3). When the compression direction is defined as the height direction, and the direction in which both side surfaces of the groove are opposed is defined as the width direction, in sections along the height direction and the width direction of the gasket (1), the area which forms the sealing surface in conjunction with the groove bottom surface (42) or the other of the surfaces of the other member among the profiles in the sections, is shaped into a arciform portion (2) composed of a curved line projected toward the other surface, before the gasket (1) is compressed between the two members. The radius of curvature (ra) and the section width (d0) of the arciform portion (2) satisfy 0.75≦ra/d0≦2.0.

### TECHNICAL FIELD

The present invention relates to a gasket and a seal structure.

### BACKGROUND ART

A gasket such as an O-ring is sandwiched and compressed between two members to thereby seal a clearance between the two members. In general, a groove into which the gasket is to be attached is formed in one of the two members. The gasket attached into the groove comes into close contact with a groove bottom surface of the groove and a surface of the other member to thereby seal the clearance between the two members. The gasket is flattened and deformed between the two members and contact surfaces with the two members function as seal surfaces.

The gasket comes in close contact with the two members without clearances therebetween to thereby exert a sealing property. However, if there are protruding and recessed portions on and in surfaces of the two members, clearances are formed between the gasket and the two members and sealed fluid may leak through them.

An aluminum die-cast part such as an engine part may have a recessed portion due to a blow hole in a finished surface. The cast part may have the blow hole when a void between particles remains inside the part after sinter forming. A surface of the cast part may be finished by cutting in some cases in order to increase dimension accuracy and flatness and the blow hole inside the part may be exposed on the surface to form the recessed portion as a result of cutting. If a size of the recessed portion is greater than a width of a seal surface of the gasket, sealed fluid may leak through the recessed portion.

Recently, to reduce a manufacturing cost by simplifying a manufacturing process, casts are used and assembled into a product in many cases. However, a sufficient sealing property may not be obtained because of occurrence of the above-described blow hole and, as a result, many seals have to be provided, the product have to be disposed of as a nonconforming product, or employment of casts have to be given up in some cases.

Conventionally, resin or liquid rubber (FIPG) is applied to the recessed portion in the seal surface to seal the clearance between the gasket and the cast part or the cast part is replaced with a part having a structure less susceptible to the blow hole to cope with this problem (see Patent Document 1). However, in machine design in recent years, miniaturization and weight reduction for securing space and improving fuel efficiency are required. Advancement of the miniaturization increases the number of shapes of products which are difficult to form and makes control tasks of defects in the manufacturing process. Therefore, some improvements are required of the gasket itself in order to cope with the blow hole.

In the past, various gasket structures have been proposed. For example, Patent Document 2 discloses a seal material having a recessed portion at a portion of a circumference of its section to be prevented from twisting when attached. Patent Document 3 discloses a low-load seal having a three-pronged section to reduce a load and variation in the load. Patent Document 4 discloses a seal having a three-pronged section to improve ease of attachment and to stabilize its attitude when attached. However, these structures aim to reduce a reaction force or to prevent falling down when they are mounted and are not intended at all to deal with a poor condition of a contact surface of an attached object.

### PRIOR-ART DOCUMENTS

### Patent Documents

Patent Document 1: Japanese Patent Application Laid-Open No. 2001-113404
Patent Document 2: Japanese Patent Application Laid-Open No. 10-318373
Patent Document 3: Japanese Patent Application Laid-Open No. 2000-356267
Patent Document 4: Japanese Patent Application Laid-Open No. 2003-322257

### DISCLOSURE OF THE INVENTION

### Problem to be Solved by the Invention

The present invention has been made to solve the above-described prior-art problem and it is its object to provide a gasket and a seal structure which can exert a sealing property without being affected by a surface state of a contact surface of an attached object, even if a recessed portion, a protruding portion, or a combination of them caused by a blow hole, a scratch, or the like is formed in or on the contact surface of the attached object.

### Solutions to the Problem

To achieve the above object, a gasket in the present invention is a gasket attached into a groove provided to one of two members, which are fixed and mounted to each other, and compressed between the two members to thereby form seal surfaces, which respectively come in close contact with a groove bottom surface of the groove and a surface of the other member, to seal a clearance between the two members, wherein a plurality of lip portions, for forming the seal surfaces in conjunction with one surface of the groove bottom surface of the groove and the surface of the other member, are provided so that a recessed portion separate from the one surface is formed between the adjacent lip portions, when a compression direction is defined as a height direction and a direction in which both side surfaces of the groove are opposed is defined as a width direction, in a section along the height direction and the width direction of the gasket, an area, which forms a seal surface in conjunction with the other surface of the groove bottom surface of the groove and the surface of the other member, of a profile of the section is an arciform portion including a curved line protruding toward the other surface, before the gasket is compressed between the two members, and a radius of curvature ra of the curved line forming the arciform portion and a width d0 of the section satisfy 0.75≦ra/d0≦2.0.

Because the radius of curvature ra of the arciform portion and the section width d0 satisfy the above-described relationship, it is possible to expand the seal surface formed in conjunction with the other surface while suppressing increase of a reaction force of the gasket in attachment.

By satisfying ra/d0≦2.0, providing the plurality of lip portions forming the seal surfaces in conjunction with the one surface, and forming the recessed portion between the lip portions, it is possible to suppress increase of the reaction force in attachment.

For example, if the two members are mounted to each other by sliding the gasket and the other member on each other, by not excessively increasing the radius of curvature ra, i.e., not making the arciform portion excessively close to a straight line, it is possible to suppress increase of sliding resistance between the gasket and the other member.

Between the one surface and the gasket, the plurality of lip portions come in contact with the one surface to thereby form a plurality of seal surfaces. In this way, increase in the reaction force of the gasket in compression is suppressed.

If 0.75≦ra/d0 is satisfied, i.e. in a case of a gasket having a circular section of a diameter of d0, if a curvature of the arciform portion is smaller than a curvature of the circular shape of the gasket, an area (seal surface) which comes in contact with the other surface becomes large when the gasket is compressed between the two members by a flattening amount substantially equal to that of the gasket having the circular section in the height direction. Here, the flattening amount refers to a difference between a height of the section of the gasket before the compression between the two members and a distance between the groove bottom surface and the surface of the other member in the height direction (a height of the gasket section after the compression between the two members). As a result, it is possible to reduce an influence of a condition of the contact surface of the attached member on the sealing property. In other words, even if protruding and recessed portions are formed on the other surface, the expanded seal surface covers the protruding and recessed portions to thereby suppress leakage through the protruding and recessed portions.

The recessed portion, the protruding portion, or the combination of them may be formed in or on the groove bottom surface or the surface of the other member with which the arciform portion comes in contact when the member with which the arciform portion comes in contact is a cast, the cast is subjected to cutting, and the recessed portion due to the blow hole is formed in the surface to be in contact with the gasket, for example. Moreover, the protruding and recessed portions may be formed due to scratches formed by surface finishing such as cutting and blasting of the groove bottom surface or the surface of the other member with which the arciform portion comes in contact. The case in which the protruding and recessed portions are formed on and in the surface to be in contact with the arciform portion is not restricted to these cases.

Therefore, in the gasket in the invention, preferably, one of the two members is a cast and the other surface with which the arciform portion comes in contact is a surface of the one of the two members which is the cast.

Furthermore, the other surface with which the arciform portion comes in contact is preferably finished by cutting or blasting. In the case of the cast, the recessed portion due to the blow hole is formed preferably.

In other words, the gasket in the invention can be used suitably when the contact surface of the opposed member is in such a condition that the surface is difficult to sufficiently seal with a prior-art gasket. Moreover, the gasket in the invention can solve the problem caused by employing the cast as the member to which the gasket is attached. Therefore, it is possible to willingly employ the cast and it is possible to contribute to reduction of the number of processes, reduction of nonconforming products, and reduction of quality control tasks.

To achieve the above object, a seal structure in the invention includes two members fixed and mounted to each other, and the gasket for sealing the clearance between the two members.

Preferably, one of the two members is a cast and the other surface with which the arciform portion of the gasket comes in contact is a surface of the one of the two members which is the cast. Moreover, the other surface with which the arciform portion of the gasket comes in contact is preferably finished by cutting or blasting. In the case of the cast, a recessed portion due to a blow hole is preferably formed.

As described above, even if the recessed portion due to the blow hole is formed in the surface to be in contact with the arciform portion of the gasket, the expanded seal surface of the gasket covers the recessed portion to thereby suppress leakage through the recessed portion. Therefore, it is possible to solve the above-described problem caused by employing the cast and it is possible to contribute to reduction of the number of processes, reduction of nonconforming products, and reduction of quality control tasks.

### Effects of the Invention

With the invention, even if a recessed portion, a protruding portion, or a combination of them due to a blow hole, a scratch, or the like is formed in or on a contact surface of an attached object, it is possible to exhibit a sealing property without being affected by the surface state of the contact surface.

### BRIEF DESCRIPTION OF THE DRAWINGS

FIG. 1 is a schematic sectional view of a gasket according to an embodiment of the present invention.

FIG. 2A is a schematic sectional view of a seal structure according to the embodiment of the invention.

FIG. 2B is a schematic sectional view of the seal structure according to the embodiment of the invention.

FIG. 3A is a schematic sectional view of the seal structure according to the embodiment of the invention.

FIG. 3B is a schematic sectional view of the seal structure according to the embodiment of the invention.

FIG. 4 is a schematic diagram for explaining a flattening amount.

FIG. 5 is a schematic diagram for explaining a flattening rate.

FIG. 6 is a schematic sectional view of a gasket according to a modification of the invention.

FIG. 7 is a table showing a result of a comparative review of performance of a gasket according to the embodiment of the invention and a comparative example.

FIG. 8 is a table showing a result of a comparative review of performance of a gasket according to the embodiment of the invention and a comparative example.

FIG. 9 shows an example of dimension setting of a sectional shape of the gasket according to the embodiment of the invention.

FIG. 10 is a table showing a result of a review of performance of gaskets according to the embodiment of the invention.

FIG. 11 is a table showing a result of a review of performance of gaskets according to the embodiment of the invention.

### MODE FOR CARRYING OUT THE INVENTION

A mode for carrying out the present invention will be described below in detail as an example based on an embodiment with reference to the drawings. However, the dimensions, materials, shapes, and relative arrangement of components described in the embodiment are not intended to be limited to the scope of the present invention, unless otherwise specifically specified.

### Embodiment

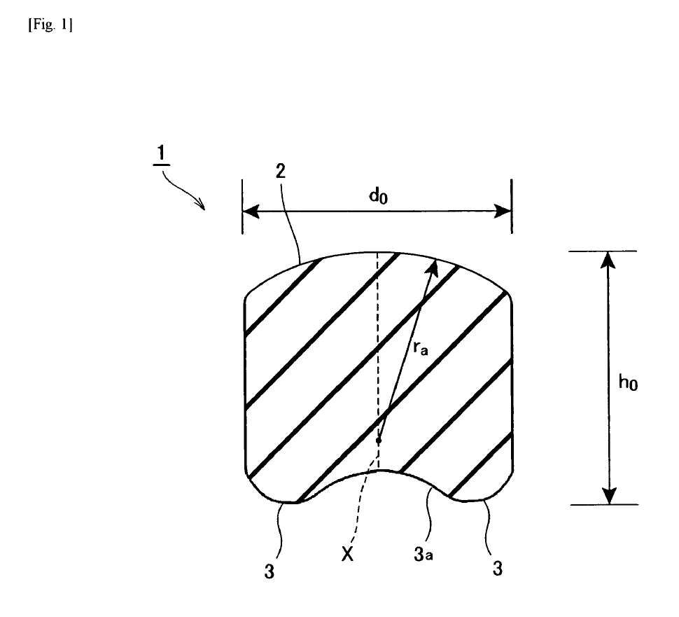

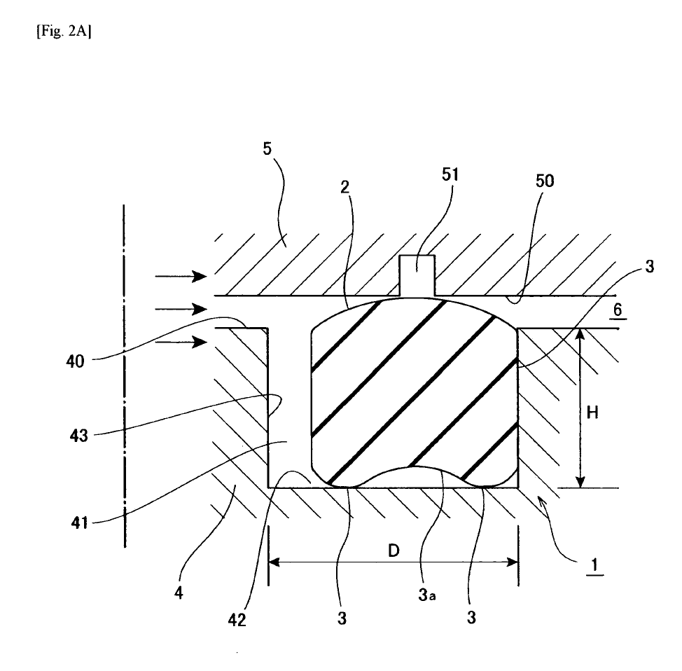

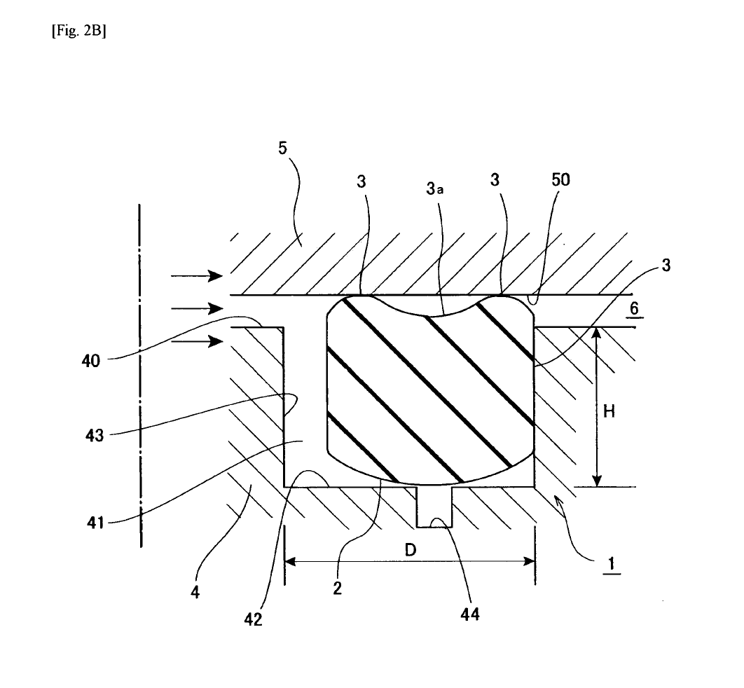

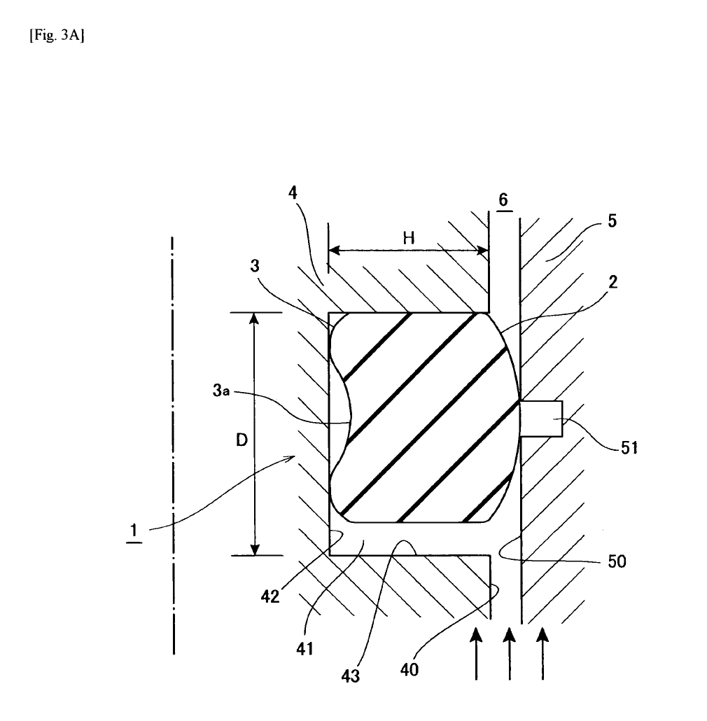

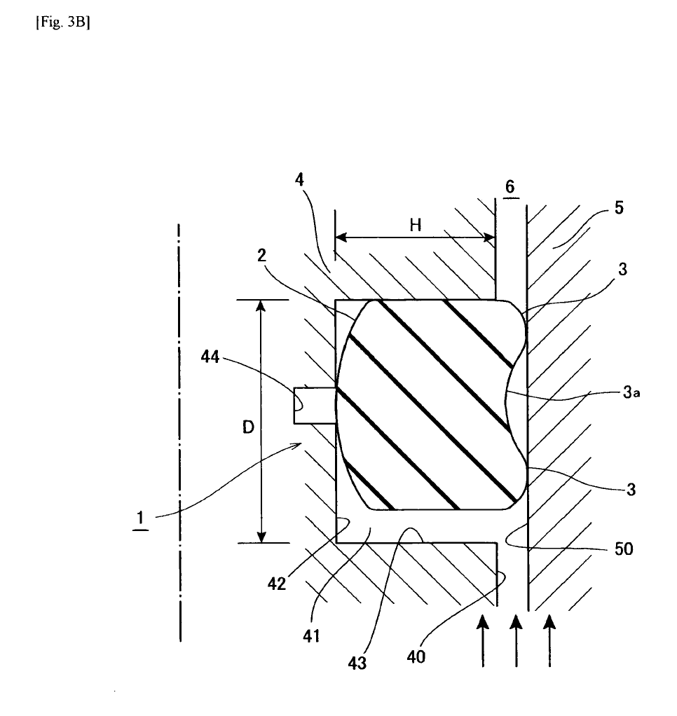

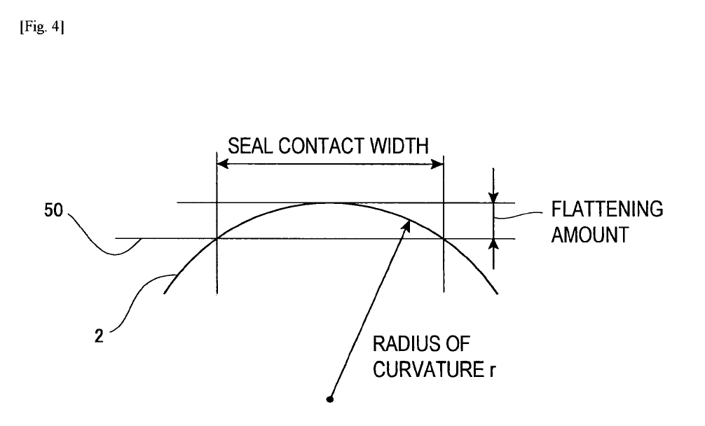

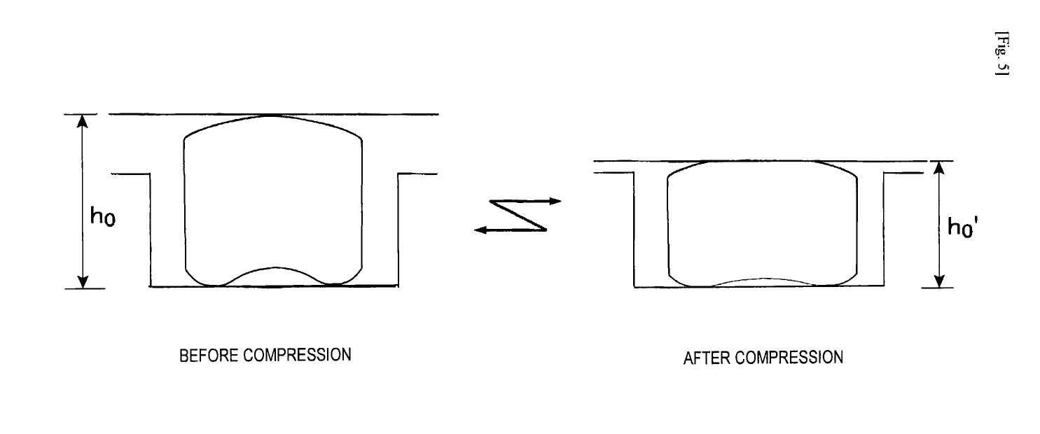

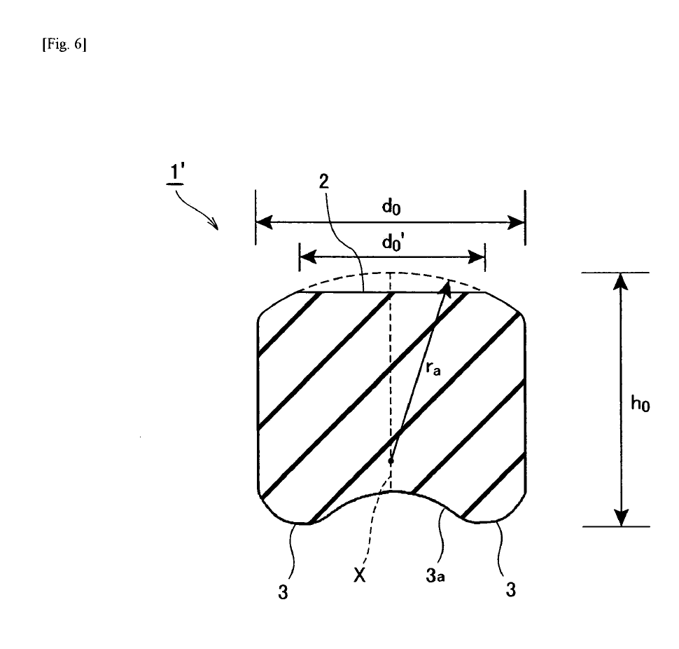

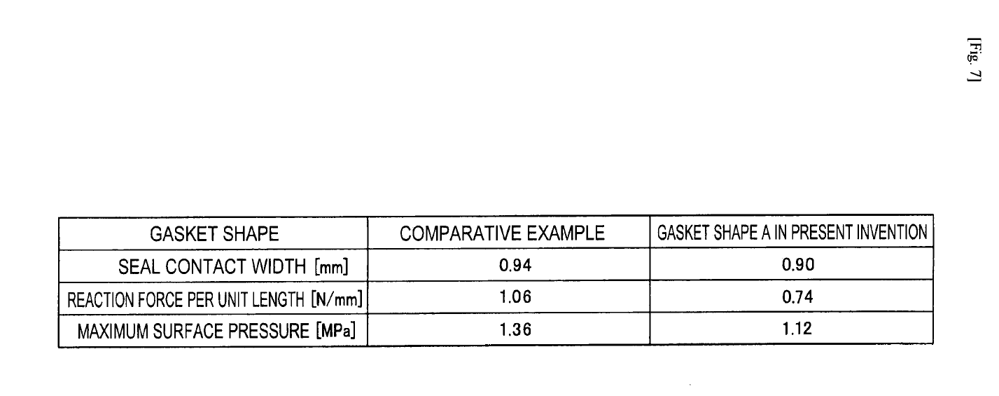

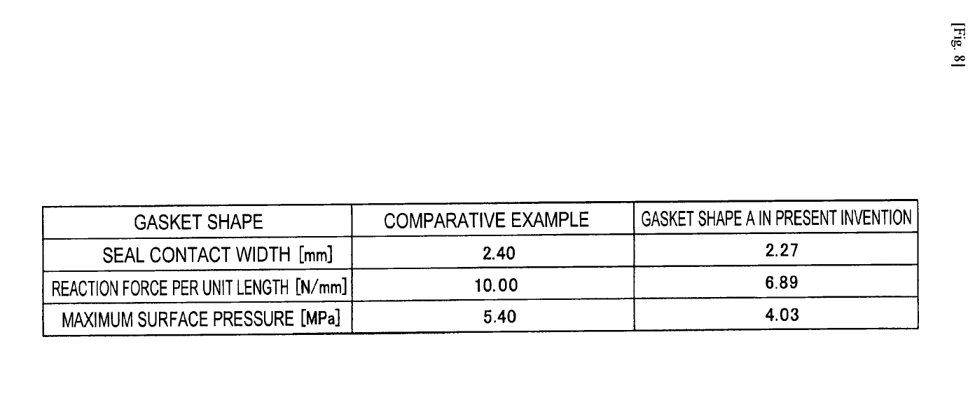

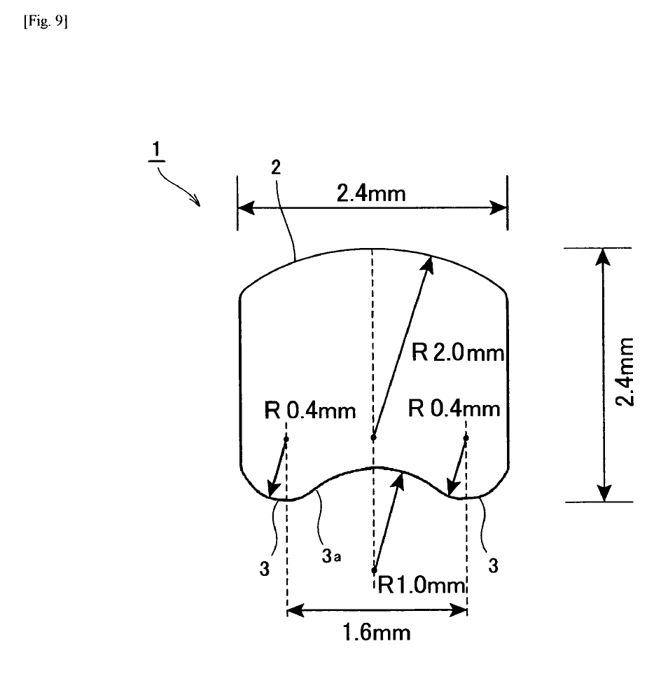

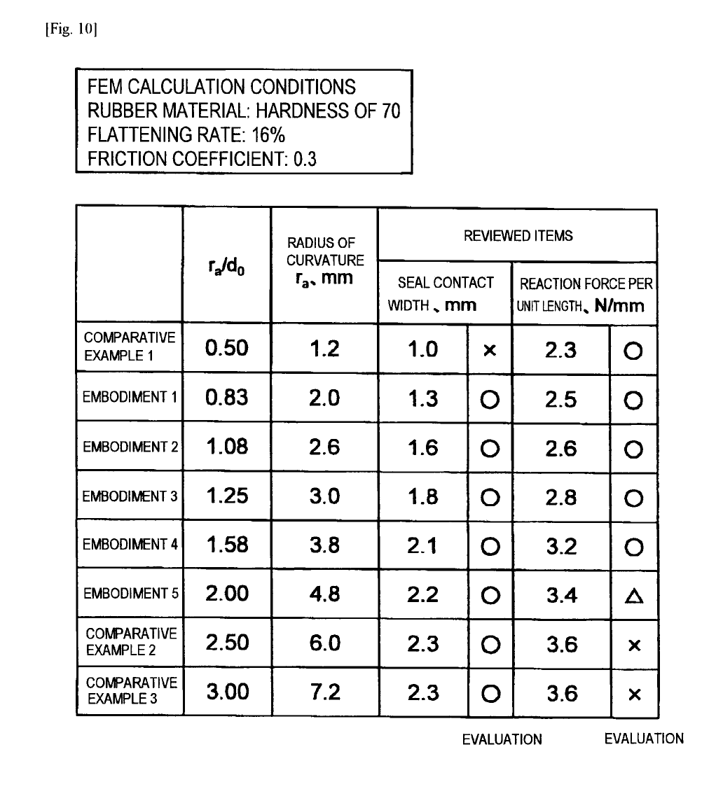

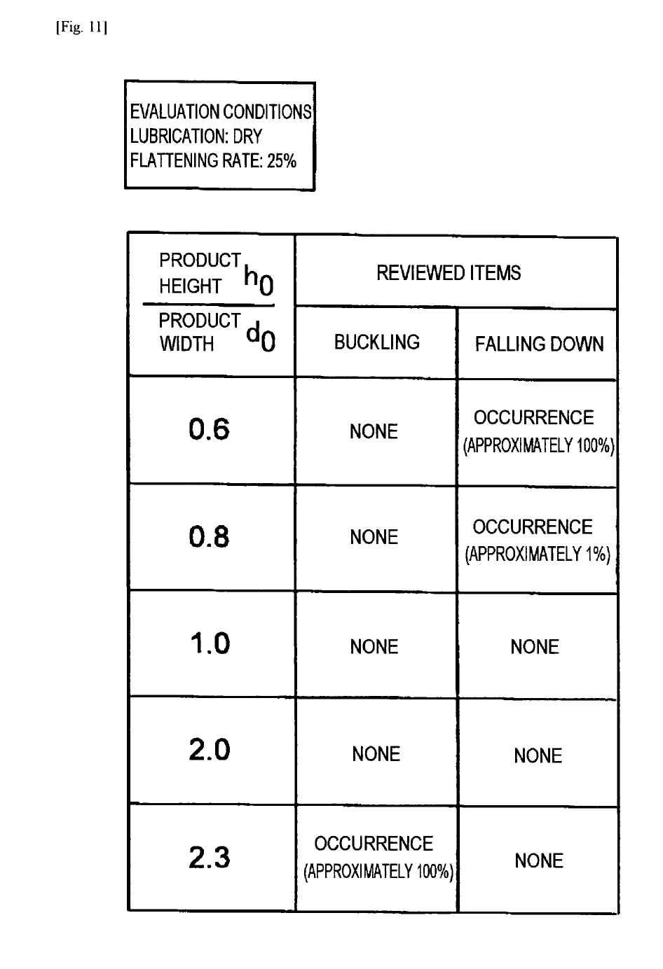

With reference to FIGS. 1 to 11, a gasket and a seal structure according to the embodiment of the invention will be described. FIG. 1 is a schematic sectional view of the gasket according to the embodiment of the invention. FIGS. 2A and 2B are schematic sectional views of the seal structure (seal for fixing flat surfaces) according to the embodiment of the invention. FIGS. 3A and 3B are schematic sectional views of the seal structure (seals for fixing cylindrical surfaces) according to the embodiment of the invention. FIG. 4 is a schematic diagram for explaining a flattening amount. FIG. 5 is a schematic diagram for explaining a flattening rate. FIG. 6 is a schematic sectional view of a gasket according to a modification of the invention. FIG. 7 is a table showing a result of a comparative review of performance of a gasket according to the embodiment of the invention and a comparative example. FIG. 8 is a table showing a result of a comparative review of performance of a gasket according to the embodiment of the invention and the comparative example. FIG. 9 shows an example of dimension setting of a sectional shape of the gasket according to the embodiment of the invention. FIGS. 10 and 11 are tables showing results of reviews of performance of gaskets according to the embodiment of the invention.

<Gasket>

The gasket 1 according to the present embodiment is made up of a rubber-like elastic body. Specific preferable examples of material of the rubber-like elastic body are acrylic rubber, nitrile rubber, and fluorine rubber.

The gasket 1 according to the embodiment is used for various devices such as automobile parts and industrial devices. To put it more concretely, it is for various uses such as in an inlet manifold, a filter blanket, a cylinder head cover, a timing belt cover, and a separator of a fuel cell. It is especially suitable as a seal of cast parts such as an aluminum die-cast product, a seal of casting surfaces, a seal of blasting surfaces, and a seal of cutting surfaces, in which recessed portions caused by blow holes are formed in contact faces.

The gasket 1 is sandwiched and compressed between opposed surfaces of two members having the opposed surfaces facing each other in each of the above-described various devices to seal a clearance between the two members. In general, a groove into which the gasket 1 is to be attached is formed in an opposed face of one of the two members. The gasket 1 is attached into the groove and comes into close contact with a groove bottom surface and a surface of the other member to thereby seal the clearance between the two members.

As shown in FIG. 1, in a section along a height direction and a width direction, the gasket 1 has a sectional shape including an arciform portion 2 forming a seal surface in conjunction with the other member, a plurality of lip portions 3 forming seal surfaces in conjunction with the groove bottom surface, and a recessed portion 3a for absorbing a compressive load. Here, the height direction is defined as a direction in which the gasket is compressed between the two members in attachment and the width direction is defined as a direction in which both side surfaces of the groove into which the gasket is attached face each other. The sectional shape of the gasket 1 is bilaterally symmetric in the width direction about a central axis X of the section extending in the height direction.

The arciform portion 2 has a smaller curvature than an arciform portion of a prior-art gasket (O-ring) having the same product width as the gasket 1 and a substantially perfect circular section. In other words, the arciform portion 2 is formed to have a larger radius of curvature ra than a radius (d0/2) of the gasket having the substantially perfect circular section. Therefore, a contact width of the seal surface of the gasket 1 according to the embodiment is greater than that of the gasket having the substantially perfect circular section, if the seal surfaces are formed when the gaskets are compressed in the same amounts in the height direction.

The lip portions 3 protrude toward the groove bottom surface 42 and have arciform sectional shapes made up of protruding curved lines. The lip portions 3 are provided in a pair and come in contact with the groove bottom surface 42 to thereby form the pair of seal surfaces between the gasket 1 and the groove bottom surface 43. The number of lip portions 3 to be provided is not especially restricted and three or more lip portions 3 may be provided.

Between the two lip portions 3, the arciform recessed portion 3a made up of a recessed curved line is formed. The recessed portion 3a is separate from the groove bottom surface 42 to form a clearance between the groove bottom surface 42 and the gasket 1. When compressed between the two members, the gasket 1 is deformed so as to reduce the clearance between the recessed portion 3a and the groove bottom surface 42 (so as to flatten the recessed portion 3a) and the sectional shape of the gasket 1 becomes a substantially rectangular shape close to a sectional shape of the groove 41. This deformation suppresses increase of a reaction force due to the compression and increases a filling rate in the groove 41 at the time of sealing. Therefore, the increase of the reaction force of the gasket 1 due to expansion of the seal surface is suppressed and a groove space can be utilized effectively.

<Seal Structure>

With reference to FIGS. 2A to 3B, the seal structure according to the embodiment will be described. The seal structure according to the embodiment is a structure for sealing the clearance 6 between the two members, i.e., one member 4 and the other member 5 with the gasket 1. The member which comes in contact with the seal surface 2 is a cast and a surface with which the gasket 1 comes in close contact is finished by adjusting dimensions and flatness by cutting. The one member 4 and the other member 5 are mounted and fixed to each other by a means which is not shown (e.g., a known means such as fitting, fastening with screws, bonding). Arrows in the drawings show a direction in which pressure of sealed fluid is applied from a sealed area to the gasket 1. FIGS. 2A and 3A show an attachment example of the gasket 1 when a recessed portion 51 may be formed in a surface of the other member 5 (e.g., when the other member 5 is the cast). On the other hand, FIGS. 2B and 3B show an attachment example of the gasket 1 when a recessed portion 44 may be formed in the groove bottom surface 42 of the groove 41 in the one member 4 (e.g., when the one member 4 is the cast). In other words, as shown in the drawings, the gasket 1 according to the embodiment is attached so that the arciform portion 2 comes in contact with the cast.

The gasket 1 according to the embodiment seals the clearance between opposed surfaces which are flat surfaces as shown in FIGS. 2A and 2B in some cases and seals the clearance between opposed surfaces which are cylindrical surfaces as shown in FIGS. 3A and 3B. An overall shape of the gasket 1 is different depending on structures of the attached members (two members). For example, in the case of the seal structure shown in FIGS. 2A and 2B, various shapes such as a circle and a polygon may be employed as a planar shape (shape seen in a vertical direction in each drawing) of the gasket 1 depending on a product to which the gasket is applied and an endless shape without end portions is employed in general. In the case of the seal structure sown in FIGS. 3A and 3B, the gasket 1 is formed in a ring shape.

The seal structure shown in FIGS. 2A and 2B will be described. In this seal structure, the two members have flat opposed surfaces opposed to each other. The groove 41 into which the gasket 1 is to be attached is formed in the opposed surface 40 of the one member 4 out of these two members and opposed to the other member 5. The gasket 1 is attached into the groove 41 and compressed and deformed so as to be flattened between the groove bottom surface 42 and the opposed surface 50 of the other member 5 to thereby seal the clearance 6 between the two members. FIGS. 2A and 2B show a state of the gasket 1 before compression between the two members. In practice, as shown in FIG. 5, the clearance 6 is narrower than that in the drawings and the gasket 1 is compressed between the groove bottom surface 42 and the opposed surface 50 in an opposed direction of the two members.

The seal structure shown in FIGS. 3A and 3B will be described. This seal structure has the opposed surfaces in shapes of cylindrical surfaces and opposed to each other. Out of these two members, the one member 4 is a shaft and the other member 5 is a housing having a shaft hole into which the shaft is inserted. In the opposed surface (outer peripheral surface) 40 of the one member 4, the annular groove 41 into which the gasket 1 is to be attached is formed. The gasket 1 is attached into the groove 41 and compressed and deformed between the groove bottom surface 42 and the opposed surface (inner peripheral surface of the shaft hole) 50 of the other member 5 to be flattened in a radial direction to thereby seal the clearance 6 between the two members. In this seal structure, the gasket 1 is first attached into the groove 41 in the shaft and then the shaft is inserted and mounted into the shaft hole in the housing. Therefore, when the shaft is mounted into the housing, the arciform portion 2 of the gasket 1 and the inner peripheral surface (opposed surface 50) of the shaft hole slide on each other. Similarly to FIGS. 2A and 2B, FIGS. 3A and 3B show a state of the gasket 1 before compression between the two members. In practice, as shown in FIG. 5, the clearance 6 is narrower than that in the drawings and the gasket 1 is compressed between the groove bottom surface 42 and the opposed surface 50 in an opposed direction of the two members.

<Dimension Setting of Gasket>

Respective dimensions of the section of the gasket 1 according to the embodiment are set as follows.

As shown in FIG. 1, a product height h0 and a product width d0 of the gasket 1 are set to be substantially equal to each other and the gasket 1 according to the embodiment has a substantially equal height to the prior-art gasket having the substantially perfect section of a diameter of d0.

In the embodiment, the respective dimensions are set so that the radius of curvature ra [mm] of the curved line forming the arciform portion 2 and the product width (section width of the gasket) d0 [mm]satisfy the following relationship.

0.75≦ra/d0≦2.0.

By satisfying 0.75≦ra/d0, it is possible to expand the seal surface formed in conjunction with the opposed surface 50. In other words, in the case of the prior-art gasket having the perfect circular section of the diameter of d0, if the curvature (1/ra) of the arciform portion 2 is smaller than a curvature (2/d0) of the circular shape of the gasket, a seal surface having a greater contact width is formed in the gasket 1 in the embodiment than in the prior-art gasket when the gasket 1 is compressed by a flattening amount equal to that of the prior-art gasket. Here, as shown in FIG. 4, the flattening amount refers to a difference between a product height h0 of the gasket 1 before the compression between the two members and a distance from the groove bottom surface 42 to the opposed surface 50 in the height direction (a product height of the gasket 1 after the compression). A flattening rate is obtained by dividing the flattening amount by the product height h0, i.e., by dividing the difference between the product height h0 and the produce height h0′ at the time of compression (sealing) by the produce height h0.

Flattening rate=(h0−h0′)/h0

By satisfying ra/d0≦2.0, it is possible to suppress increase of the reaction force at the time of attachment. If the two members are mounted to each other by sliding the gasket 1 and the opposed surface 50 on each other as in the structure in FIG. 3A, by not excessively increasing the radius of curvature ra, i.e., not making the arciform portion 2 excessively close to a straight line, it is possible to suppress increase of sliding resistance between the gasket 1 and the opposed surface 50.

To suppress buckling at the time of compression, falling down due to the sliding on the opposed surface 50, and increase of the reaction force, the product height h0 and the product width d0 are set so that an aspect ratio (product height h0/product width d0) of the sectional shape is in the following range.

0.8≦h0/d0≦2.0

To further reduce the reaction force, a flat portion 2a may be formed at a center of the arciform portion 2 as in a gasket 1′ according to a modification shown in FIG. 6. A width d0′ of the flat portion 2a has the following relationship with the product width d0.

d0>d0′>0

FIG. 7 shows a result of a comparative review of performance of a gasket according to the embodiment of the invention and a gasket as a comparative example having a D-shaped section. This review is about the gasket for fixing the flat surfaces shown in FIG. 2A and, as the gasket according to the embodiment, a gasket made of rubber material having harness equivalent to hardness of 70 and having an inner diameter of 21.8 mm, h0 of 2.4 mm, and d0 of 2.4 mm was used. A specific example of dimension setting of a sectional shape of the gasket employed as the embodiment is shown in FIG. 9. Used as the gasket of the comparative example was the gasket made of the same rubber material and having the same inner diameter as the gasket of the embodiment, not having the recessed portion as in the gasket of the embodiment, and having a substantially D-shaped section satisfying the above-described relationship between the radius of curvature of the arciform portion and the product width similarly to the embodiment. Both of these gaskets satisfied ra/d0=0.83. A seal contact width, a reaction force per unit length, and maximum surface pressure when each of these gaskets was compressed at a flattening rate of 8% were calculated from an FEM analysis.

As shown in FIG. 7, the gasket according to the embodiment had substantially the same contact width of the seal surface as the gasket of the comparative example and had significantly reduced reaction force and reduced maximum surface pressure. Therefore, if the gasket is designed to have the same reaction force, the gasket can cover and seal a larger recessed portion than the gasket of the comparative example in sealing the clearance between the two members having the recessed portion in their contact surfaces.

FIG. 8 shows a result of a comparative review of performance of both the gaskets when the gaskets were compressed under the same conditions as in the above-described review shown in FIG. 7 except that the flattening rate was 25%. As shown in FIG. 8, even if the flattening rate changes, tendencies of both the gaskets with regard to the contact width of the seal surface, the reaction force, and the maximum surface pressure do not change.

A table in FIG. 10 shows a result of a review showing changes of the seal contact width and the reaction force when only the radius of curvature ra was changed in the gasket shape shown in FIG. 9 as a basic shape. As shown in the result of the review, when ra was increased, the reaction force increased as the seal contact width increased. However, while the reaction force increased relatively slowly and became saturated, the seal contact width increased relatively greatly. Therefore, if ra=1.2 mm was a standard, an effect of increasing the seal contact width became noticeable from around ra/d0=0.75. On the other hand, if ra/d0 exceeded 2.00, a value of the reaction force became 1.5 times a standard value, which was not suitable to actual use and the effect of increasing the seal contact width peaked.

A table in FIG. 11 shows a result of a review of whether the buckling and the falling down were caused by the change of h0/d0. The gasket used for this review satisfied ra/d0=0.83. The buckling is a phenomenon mainly caused in the gasket for fixing flat surfaces as shown in FIGS. 2A and 2B, in which, when the gasket is attached into the groove and then compressed between the two members, the gasket is not flattened in the vertical direction as planned and is distorted in a lateral direction. If this phenomenon occurs, a prescribed sealing property cannot be obtained and the gasket is not suitable to actual use. The falling down is a phenomenon mainly caused in the gasket for fixing the cylindrical surfaces as shown in FIGS. 3A and 3B, in which, when the gasket is fixed to the one member and then slid into the predetermined position of the other member, apart of the fixed gasket falls down due to the sliding resistance and the gasket is fixed while twisted. If this phenomenon occurs, a prescribed sealing property cannot be obtained and, in the worst case, the gasket is damaged by the twist.

As shown in the result of the review, the buckling phenomenon did not occur when h0/d0=2.0 or smaller but occurred 100% of the time when h0/d0=2.3. The falling down phenomenon was noticeable when h0/d0 was smaller than 0.8. Consequently, the shape with which occurrence of both the phenomena can be avoided is restricted to a range of h0/d0=0.8 to 2.0.

### Advantages of the Embodiment

According to the embodiment, the radius of curvature ra of the arciform portion 2 and the section width d0 satisfy the above-described relationship and the plurality of lip portions 3 are provided to form the recessed portion 3a. As a result, it is possible to reduce an influence of a condition of the contact surface of the attached member on the sealing property while suppressing increase of the reaction force of the gasket at the time of attachment. In other words, with each of the gaskets shown in FIGS. 2A and 3A when the recessed portion 51 is formed in the surface 50 of the other member and with each of the gaskets shown in FIGS. 2B and 3B when the recessed portion 44 is formed in the groove bottom surface 42 of the attaching groove 41, the seal surface which is expanded by the arciform portion 2 covers the recessed portion 44 or 51 to thereby suppress leakage of the sealed fluid or the like through the recessed portion 44 or 51.

The poor condition of the contact surface of the attached member is not restricted to the above-described case in which the recessed portion 44 or 51 is formed in the groove bottom surface 42 or the surface 50 of the other member due to the blow hole. For example, a recessed portion, a protruding portion, or a combination of them may be formed due to a scratch formed by surface finishing such as cutting and blasting in or on the groove bottom surface 42 or the surface 50 of the other member.

Because the recessed portion 3a is formed, the increase of the reaction force is suppressed. Because the increase of the reaction force of the gasket 1 is suppressed, the gasket 1 is suitable to a case in which both or one of the two members are (is) (a) resin member (s) which are (is) more likely to be deformed than metal members.

Even if the recessed portions are not formed in the surfaces of the two members, the gasket can be used as a gasket similar to the prior-art gasket.

According to the embodiment, it is possible to solve the problem caused by employing the casts. Therefore, it is possible to willingly employ the casts while contributing to reduction of the number of processes, reduction in nonconforming products, and reduction of quality control tasks.

### DESCRIPTION OF REFERENCE SIGNS

1 gasket
2 arciform portion
3 lip portion
3a recessed portion
4 one member
40 surface
41 groove
42 groove bottom surface
43 groove bottom surface
5 the other member
50 surface
51 recessed portion
6 clearance

1. A gasket attached into a groove provided to one of two members, which are fixed and mounted to each other, and compressed between the two members to thereby form seal surfaces, which respectively come in close contact with a groove bottom surface of the groove and a surface of the other member, to seal a clearance between the two members,
wherein a plurality of lip portions, for forming the seal surfaces in conjunction with one surface of the groove bottom surface of the groove and the surface of the other member, are provided so that a recessed portion separate from the one surface is formed between the adjacent lip portions,
when a compression direction is defined as a height direction and a direction in which both side surfaces of the groove are opposed is defined as a width direction, in a section along the height direction and the width direction of the gasket, an entire area, which forms a seal surface in conjunction with the other surface of the groove bottom surface of the groove and the surface of the other member having a recessed portion, a protruding portion, or a combination of them and which is opposed to the other surfaces, of a profile of the section is an arciform portion including a perfect-circular curved line protruding toward the other surface, before the gasket is compressed between the two members,
a radius of curvature ra of the curved line forming the arciform portion and width d0 of the section satisfy 0.75≦ra/d0≦2.0, and
a height h0 of the section and a width d0 of the section satisfy 0.8≦h0/d0≦2.0.

2. The gasket according to claim 1,
wherein one of the two members is a cast and
the other surface with which the arciform portion comes in contact is a surface of the one of the two members which is the cast.

3. The gasket according to claim 1, wherein the other surface with which the arciform portion comes in contact is finished by cutting or blasting.

4. The gasket according to claim 2, wherein a recessed portion due to a blow hole is formed in the other surface with which the arciform portion comes in contact.

5. A seal structure comprising:
two members fixed and mounted to each other; and
the gasket according to claim 1 for sealing the clearance between the two members.

6. The seal structure according to claim 5,
wherein one of the two members is a cast and
the other surface with which the arciform portion of the gasket comes in contact is a surface of the one of the two member which is the cast.

7. The seal structure according to claim 5, wherein the other surface with which the arciform portion of the gasket comes in contact is finished by cutting or blasting.

8. The seal structure according to claim 6, wherein a recessed portion due to a blow hole is formed in the other surface with which the arciform portion of the gasket comes in contact.

9. The gasket according to claim 3, wherein a recessed portion due to a blow hole is formed in the other surface with which the arciform portion comes in contact.

10. The seal structure according to claim 7, wherein a recessed portion due to a blow hole is formed in the other surface with which the arciform portion of the gasket comes in contact.
